(19) United States
(12) Patent Application Publication
(10) Pub. No.: US 2008/0159205 A1
(43) Pub. Date: Jul. 3, 2008

(54) WIRELESS COMMUNICATION APPARATUS

(76) Inventors: Masahiro Sekiya, Tokyo (JP); Tomoko Adachi, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/961,201

(22) Filed: Dec. 20, 2007

(30) Foreign Application Priority Data
Dec. 25, 2006 (JP) 2006-348001

(51) Int. Cl. H04Q 7/00

(52) U.S. Cl. 370/328; 370/445

(57) ABSTRACT

According to an aspect of the invention, there is provided a wireless communication apparatus including an aggregation frame creating section which creates an aggregation frame into which a plurality of MAC frames are integrated, a transmission section which transmits the aggregation frame to a destination apparatus, a reception section which receives a delivery acknowledgment response frame including information indicating whether or not each of the MAC frames in the aggregation frame has safely been received, a time measurement section which measures a time for which reception of the delivery acknowledgment response frame is waited, and a selection section which selects retransmission of the aggregation frame to the destination apparatus or transmission of a delivery acknowledgment request frame requesting the delivery acknowledgment response frame when the reception section has not received the delivery acknowledgment response frame after the time measured by the time measurement section has reached a predetermined time.

### CROSS-REFERENCE TO RELATED APPLICATIONS

This application is based upon and claims the benefit of priority from prior Japanese Patent Application No. 2006-348001, filed Dec. 25, 2006, the entire contents of which are incorporated herein by reference.

### BACKGROUND OF THE INVENTION

1. Field of the Invention

The present invention relates to a wireless communication apparatus.

2. Description of the Related Art

A method used in a wireless communication system in which a plurality of wireless communication apparatuses communicate, and share a medium with each other, is known, the method being a method in which each of the wireless communication apparatuses performs carrier sensing before transmitting a frame so as to confirm the status of use of the wireless channel. Carrier sensing is performed and, while one wireless communication apparatus is performing transmission, the other wireless communication apparatuses are in the transmission-waiting state, whereby it becomes possible to avoid a collision between frames as far as possible.

For example, the Institute of Electrical and Electronics Engineers (IEEE) 802.11 standard has been established for wireless communication systems that perform carrier sensing. In this IEEE 802.11 standard, a protocol of the medium access control (MAC) layer and a protocol of the physical layer are provided. The medium access control is a technique for controlling timings at which a plurality of communication apparatuses transmit communication data. In the physical layer, there are provisions relating to a data transmission rate of communication, a wireless frequency band, and the like.

In a wireless LAN system of the IEEE 802.11 standard, the 2.4-GHz band is used, and the maximum data transmission rate is 2 Mbps. Heretofore, speed enhancement of the data transmission rate has been realized by mainly changing the protocol in the physical layer. At present, the IEEE 802.11g wireless LAN standard (established in 2003) utilizes the 2.4-GHz band, and IEEE 802.11a (established in 1999) utilizes the 5-GHz band, and the maximum data transmission rate is 54 Mbps in both standards. Further, in order to aim at a wireless LAN standard for realizing greater speed enhancement, a study on the MAC layer and the physical layer is now being advanced.

In the wireless LAN system, as a technique for improving a throughput in the MAC layer, frame aggregation by which a plurality of MAC frames are integrated into one frame so as to be transmitted is known. In the document [Adrian Stephens, et al., “Joint Proposal: High throughput extension to the 802.11 Standard: MAC”, IEEE 802.11-05/1095r5, January, 2006], the MAC layer technique studied in IEEE 802.11n is mentioned, and a communication method using the frame aggregation is described.

Heretofore, in the MAC layer provided in IEEE 802.11, each MAC frame is separately transmitted. In the frame aggregation, a plurality of MAC frames are joined to each other, transferred to the physical layer as a long MAC frame, and subjected to modulation processing so as to be transmitted. By this method, it becomes possible to reduce an inter frame space (IFS) between frames to be transmitted, and a transmission time of the physical layer header.

In a wireless communication system in which a transmission source wireless communication apparatus transmits an aggregation frame in which a plurality of MAC frames are integrated into one frame to a destination wireless communication apparatus, the destination wireless communication apparatus transmits a delivery acknowledgment response frame within a specified time. In this delivery acknowledgment response frame, information indicating whether or not the destination wireless communication apparatus can receive each MAC frame in the aggregation frame is included.

In the conventional wireless communication system, when the transmission source wireless communication apparatus does not receive a delivery acknowledgment response frame within a specified time after transmission of the aggregation frame, there is a mechanism in which the transmitted aggregation frame is retransmitted or the delivery acknowledgment response frame is reclaimed by transmitting a delivery acknowledgment request frame.

However, in the conventional technique, there is no method for determining whether the transmission source wireless communication apparatus is to retransmit the same aggregation frame or is to transmit a delivery acknowledgment request frame. Accordingly, when a delivery acknowledgment response frame is not received within a specified time after an aggregation frame is transmitted, an inappropriate frame is transmitted, whereby an extra frame exchange is caused, and the efficiency is poor. Further, an extra frame is transmitted, thereby giving rise to an increase in the electrical power consumption of the wireless communication apparatus.

### BRIEF SUMMARY OF THE INVENTION

According to an aspect of the invention, there is provided a wireless communication apparatus comprising: an aggregation frame creating section which creates an aggregation frame into which a plurality of MAC frames are integrated; a transmission section which transmits the aggregation frame created by the aggregation frame creating section to a destination apparatus; a reception section which receives a delivery acknowledgment response frame including information indicating whether or not each of the MAC frames in the aggregation frame has safely been received from the destination apparatus; a time measurement section which measures a time for which reception of the delivery acknowledgment response frame is waited; and a selection section which selects retransmission of the aggregation frame to the destination apparatus or transmission of a delivery acknowledgment request frame requesting the delivery acknowledgment response frame when the reception section has not received the delivery acknowledgment response frame after the time measured by the time measurement section has reached a predetermined time.

### BRIEF DESCRIPTION OF THE SEVERAL VIEWS OF THE DRAWING

FIG. 1 is a view showing a configuration example of a wireless LAN system which is a wireless communication system according to a first embodiment.

FIG. 2 is a view showing a configuration example in which the wireless LAN system according to the first embodiment is connected to another wireless LAN system.

FIG. 3 is a view showing a configuration example of a wireless communication apparatus applied to the wireless communication system according to the first embodiment.

FIG. 4 is a view showing a configuration example of a typical MAC frame used in the wireless LAN system according to the IEEE 802.11 standard according to the first embodiment.

FIG. 5 is a view showing a configuration example of a frame in the case where a plurality of MAC frames are integrated into one PSDU according to the first embodiment.

FIG. 6 is a view showing an example of a frame sequence according to the first embodiment.

FIG. 7 is a view showing an example of a frame sequence in the case where an error occurs in a MAC frame in a PSDU according to the first embodiment.

FIG. 8 is a view showing an example of a frame sequence in the case where a delivery acknowledgment response frame according to the first embodiment is not received.

FIG. 9 is a view showing an example of a frame sequence in the case where a delivery acknowledgment response frame according to the first embodiment is not received.

FIG. 10 is a flowchart showing a communication control method according to the first embodiment.

FIG. 11 is a flowchart showing a communication control method according to a second embodiment.

FIG. 12 is a view showing an example of a frame sequence according to a third embodiment.

FIG. 13 is a view showing an example of a frame sequence according to a fourth embodiment.

FIG. 14 is a view showing an example of a frame sequence according to the fourth embodiment.

### DETAILED DESCRIPTION OF THE INVENTION

Embodiment will be described below with reference to the accompanying drawings.

In a first embodiment, when a delivery acknowledgment response frame is not received within a specified time after a transmission source wireless communication apparatus transmits an aggregation frame to a destination wireless communication apparatus, a frame to be transmitted next is selected on the basis of a judgment based on a reception status in the specified time. The transmission source wireless communication apparatus selects retransmission of the same aggregation frame or transmission of a delivery acknowledgment request frame in accordance with the wireless state.

FIG. 1 is a view showing an example of a communication form of a wireless LAN system according to the IEEE 802.11 standard which is a wireless communication system according to the first embodiment. In FIG. 1, a plurality of wireless terminals 102 and 103 are connected to one wireless base station 101 in a wireless manner. A unit constituted of the wireless base station and one or a plurality of wireless terminals is called a basic service set (BSS) in the IEEE 802.11 standard.

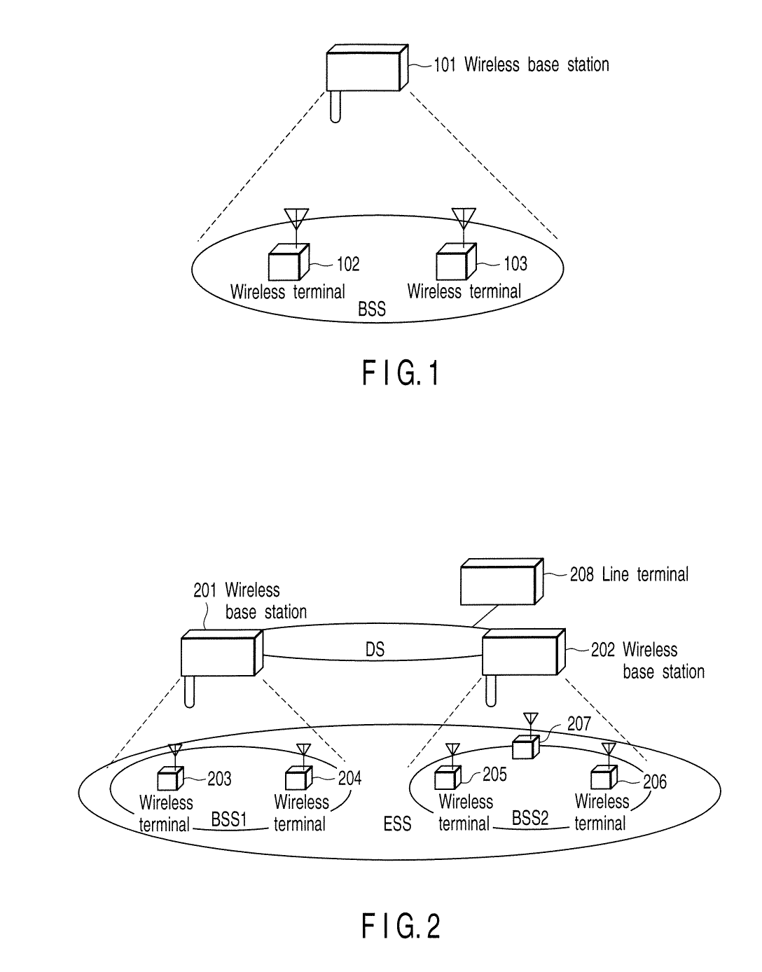

Although FIG. 1 shows a wireless communication system constituted of one BSS 101, the wireless communication system may be constituted of a plurality of BSSs (BSS1 and BSS2) as shown in FIG. 2. Such a form of a wireless communication system is called an extended service set (ESS) in the IEEE 802.11 standard. A part between the wireless base stations 201 and 202 is called a distributed system (DS), and the base stations 201 and 202 may be connected to each other wirelessly or by wire.

In the first embodiment, the configuration of a wireless communication system as shown in FIG. 1 is employed, and the wireless base station 101 and the wireless terminal 102 existing in the same BSS are each provided with a single antenna. However, the wireless base station and the wireless terminal may be each provided with a plurality of antennas capable of transmitting and receiving a plurality of data streams. Alternatively, a wireless base station provided with a plurality of antennas and wireless terminals each provided with a single antenna may coexist in the BSS. A description will be given of an example of the wireless communication system described above.

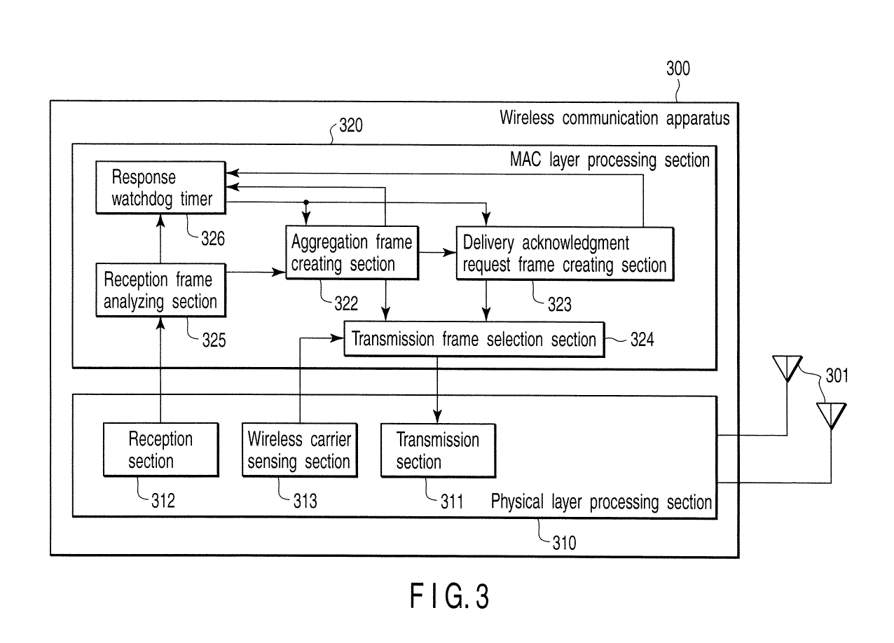

FIG. 3 is a view showing a configuration example of a wireless communication apparatus to be applied to a wireless communication system according to the first embodiment.

A wireless communication apparatus 300 shown in FIG. 3 is an apparatus for communicating with another wireless communication apparatus through a wireless channel, and is provided with a physical layer processing section 310 for performing processing in the physical layer for realizing wireless communication, and a MAC layer processing section 320 for performing processing in the medium access control (MAC) layer. The physical layer processing section 310 and the MAC layer processing section 320 may be realized as an analog circuit or a digital circuit or the like, or may be realized by software or the like executed by a CPU. Antennas 301 are connected to the physical layer processing section 310. The number of antennas may be one or more than one in accordance with communication processing to be implemented.

The physical layer processing section 310 performs physical layer protocol processing for realizing communication processing to be implemented. In order to perform the processing, the physical layer processing section 310 includes a transmission section 311 for transmitting a frame transferred from the MAC layer processing section 320 to the wireless channel, a reception section 312 for processing a wireless signal received from the antenna 301, and a wireless carrier sensing section 313 for performing carrier sensing. Incidentally, the physical layer protocol to be implemented is not limited to one type. The configuration may be made so as to be compatible with two or more types of physical layer protocols.

The MAC layer processing section 320 performs MAC layer protocol processing for realizing communication processing to be implemented. The MAC layer processing section 320 is provided with an aggregation frame creating section 322 for integrating MAC frames, a delivery acknowledgment request frame creating section 323 for creating a delivery acknowledgment request frame for requesting a delivery acknowledgment response frame, a transmission frame selection section 324 for selecting a frame from frames output from the aggregation frame creating section 322 or the delivery acknowledgment request frame creating section 323, a reception frame analyzing section 325 for analyzing a frame transferred from the physical layer processing section 310, and a response watchdog timer 326 for defining a period of time during which reception of a response frame is awaited.

In this first embodiment, the case where the wireless base station 101 transmits a frame to the wireless terminal 102 in the wireless LAN system according to the IEEE 802.11 standard shown in FIG. 1 will be described below as an example. The wireless base station 101 and the wireless terminal 102 have the same configuration as the wireless communication apparatus 300 shown in FIG. 3. The description can also be applied to the case where conversely, the wireless terminal 102 transmits a frame to the wireless base station 101. The frame used by the wireless base station 101 and the wireless terminal 102 to perform communication may be a type of control frame of the medium access control (MAC) frame in the IEEE 802.11 standard, or may be a management frame or a data frame.

In the first embodiment, a description will be given of a retransmission control method in the case where the wireless base station 101 which transmits a frame including a plurality of MAC frames integrated into one PLCP service data unit (PSDU) as a PLCP protocol data unit (PPDU) cannot receive a delivery acknowledgment response frame from the wireless terminal 102. Incidentally, the PPDU is a physical frame including a PHY (physical layer) header and a PSDU.

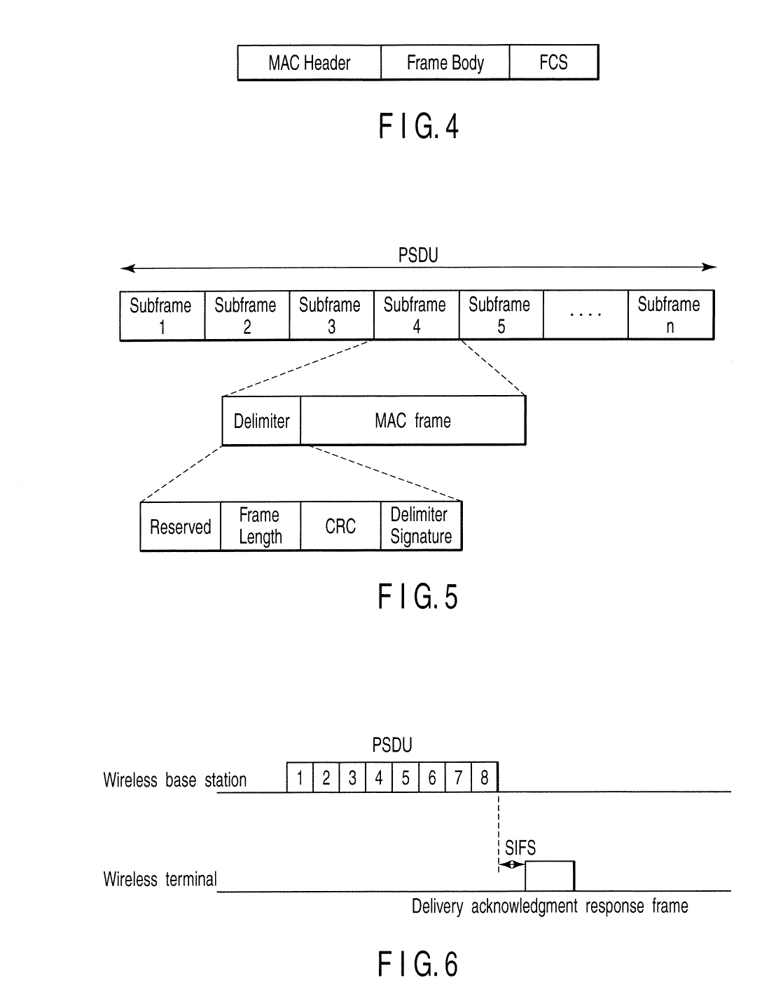

Here, the configuration of a MAC frame in the wireless LAN system of the IEEE 802.11 standard is shown in FIG. 4. The MAC frame is constituted of a MAC header section in which information necessary for reception processing is set, a frame body section in which information corresponding to a frame type (data or the like from upper layers) is set, and a frame check sequence (FCS) section in which a cyclic redundancy check (CRC) code used to determine whether or not the MAC header section and the frame body section can be received normally is set.

In the MAC header section, included are a frame control field in which a value corresponding to a frame type is set, a duration/ID field indicating a period (network allocation vector [NAV]) in which transmission is suppressed, MAC address fields (present in the plural number) in each of which MAC addresses of a direct transmission destination, final destination, and transmission source are set, a sequence control field in which a sequence number of data to be transmitted and a fragment number of fragmentation are set, and the like. Incidentally, in the frame control field, included are a type field indicating a type of field, subtype field, a ToDS bit indicating whether or not a frame is addressed to DS (i.e., addressed to the wireless base station), a FromDS bit indicating whether or not a frame is transmitted from DS (i.e., from the wireless base station), and the like.

Further, a configuration example of an aggregation frame in which a plurality of MAC frames are included in a single PSDU is shown in FIG. 5. The PSDU frame is configured as a frame in which n pieces (n is a positive integer) of subframes are concatenated. Each subframe is constituted of a delimiter field for detecting a border of a subframe, and a MAC frame. In the delimiter field, included are a reserved subfield which is unused in the present state, information (frame length subfield) indicating a length of a succeeding MAC frame, a CRC subfield for detecting an error of the reserved subfield and the frame length subfield, and a delimiter signature subfield in which a bit string for recognizing that the delimiter field is a delimiter is set. As described above, a delimiter field is present at a head of each subframe, and a length of a succeeding MAC frame can be recognized by confirming a value set in the frame length subfield included in the delimiter field.

A frame sequence example is shown in FIG. 6, in which the wireless base station 101 transmits an aggregation frame to the wireless terminal 102, and after an elapse of a short interframe space (SIFS), the wireless base station 101 receives a delivery acknowledgment response frame from the wireless terminal 102.

Here, the SIFS is the minimum frame interval in the IEEE 802.11 standard. In FIG. 6, the wireless base station 101 transmits a PSDU into which eight pieces of MAC frames having numbers 1 to 8 set as sequence numbers are integrated. Upon receipt of a PSDU into which the plural MAC frames are integrated, the wireless terminal 102 transmits a delivery acknowledgment response frame indicating whether or not each MAC frame can normally be received.

In this delivery acknowledgment response frame, included are a frame control field, a duration/ID field, a destination MAC address, a transmission source MAC address, a starting point sequence number, and a bitmap field which has a fixed length of 64 bits and in which ‘0’ or ‘1’ is set as a reception record. In the bitmap field, past reception records of MAC frames starting from a starting point sequence number are set from the head of the frame as ‘0’ or ‘1’, thereby informing the past reception records of MAC frames. When a MAC frame is normally received, ‘1’ is set at a bit position of the bitmap field corresponding to the sequence number of the MAC frame. When the MAC frame is not received normally, ‘0’ is set at a bit position of the bitmap field corresponding to the sequence number of the MAC frame.

In the sequence shown in FIG. 6, when all the eight pieces of MAC frames from the wireless base station 101 can normally be received, the wireless terminal 102 sets a starting point sequence number included in the delivery acknowledgment response frame to ‘1’, and sets 1111111100 . . . in the bitmap field. In this case, the wireless terminal 102 succeeds in receiving only eight pieces of MAC frames. Accordingly, bits in the bitmap field from the ninth to sixty-fourth bit are all set to ‘0’.

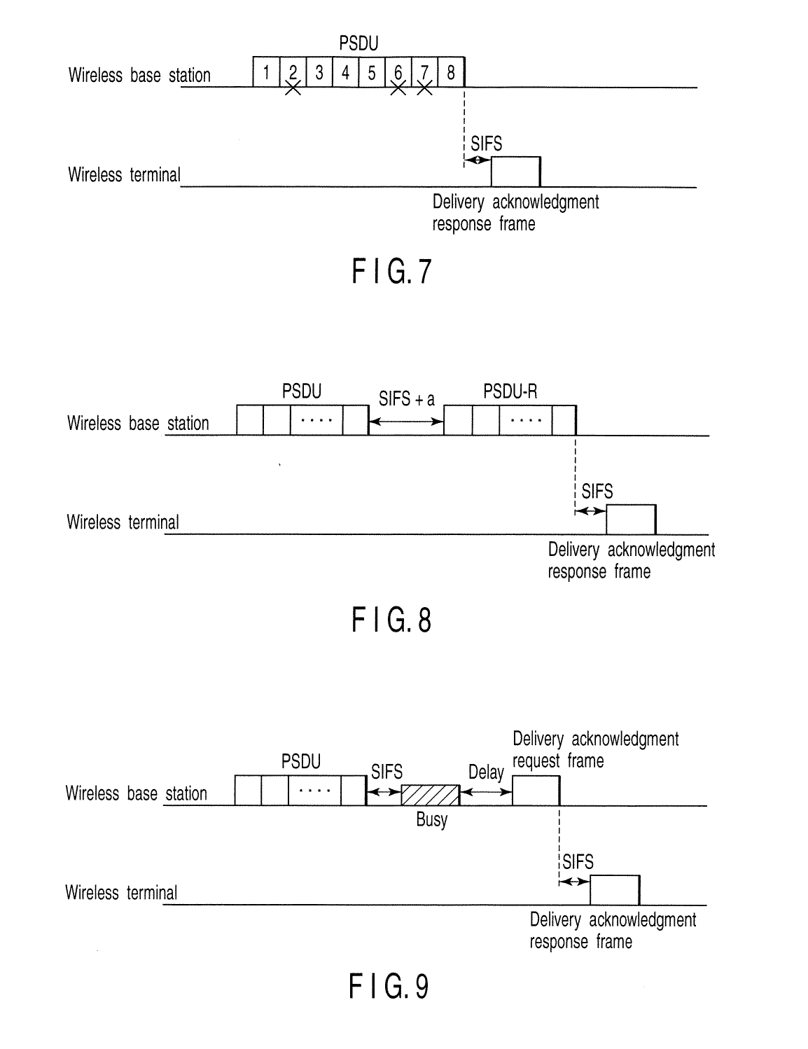

In the sequence example of FIG. 7, the case is shown where errors occur in the MAC frames of the eight pieces of MAC frames received by the wireless terminal 102 having the sequence numbers 2, 6, and 7 as a result of an FCS check. In this case, the starting point sequence number included in the delivery acknowledgment response frame is set to ‘1’, and 1011100100 . . . is set in the bitmap field. Upon receipt of this delivery acknowledgment response frame, the wireless base station 101 determines that the MAC frames having the sequence numbers 1, 3, 4, 5, and 8 have successfully been transmitted, and further recognizes that the remaining MAC frames having the sequence numbers 2, 6, and 7 have unsuccessfully been transmitted. Further, the wireless base station 101 performs processing for retransmitting the MAC frames of the numbers 2, 6, and 7.

When the delivery acknowledgment response frame can normally be received from the wireless terminal as described above, the processing to be performed next is quite clear. However, the control method to be used when the delivery acknowledgment response frame cannot be normally received has not clearly been provided. The case where control is performed in accordance with the first embodiment will be described below.

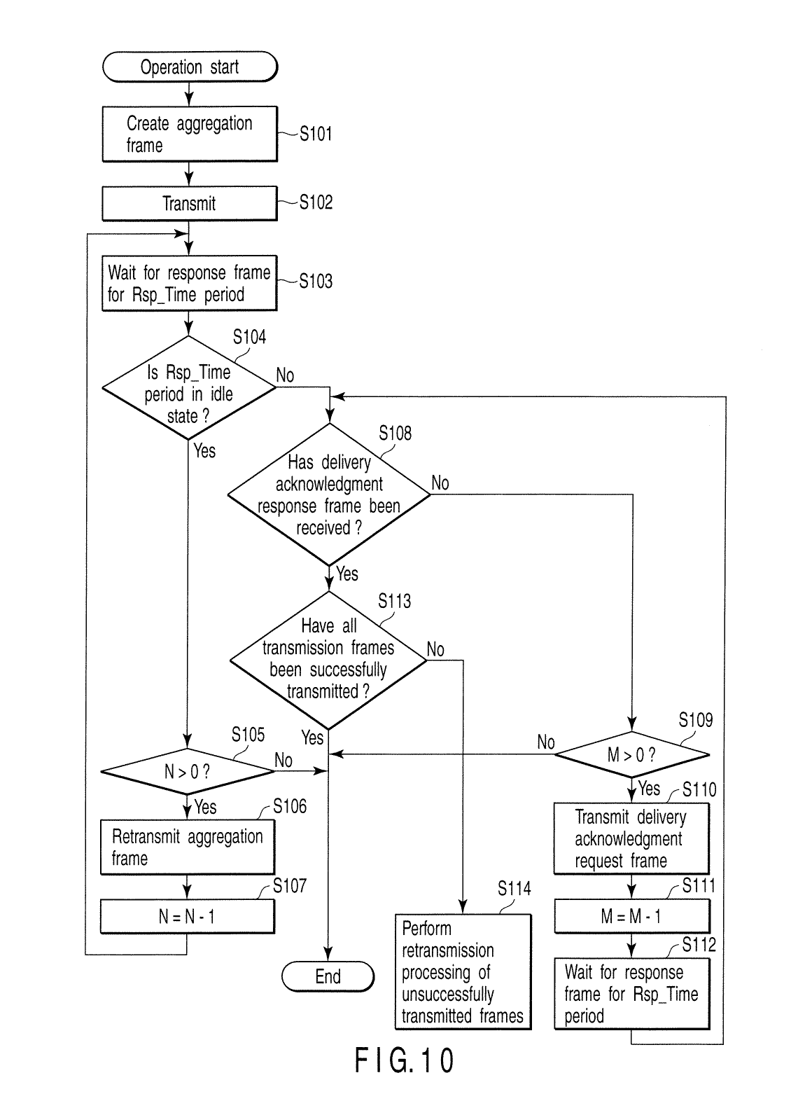

The communication control method to be employed when the wireless base station 101 receives no delivery acknowledgment response frame will be described below with reference to frame sequences shown in FIGS. 8 and 9 and a flowchart show in FIG. 10.

The sequence shown in each of FIGS. 8 and 9 is a sequence in which the wireless base station 101 transmits a PSDU into which a plurality of MAC frames are integrated to the wireless terminal 102, and then requires a delivery acknowledgment response frame. A difference between the above two sequences is whether or not a radio signal is detected in the wireless channel as a result of performing carrier sensing in the response-waiting time after the wireless base station 101 first transmits a PSDU. FIG. 8 shows a retransmission sequence of the case where a radio signal is not detected, and FIG. 9 shows a retransmission sequence of the case where a radio signal is detected.

Next, the operation of the wireless base station 101 will be described below on the basis of the flowchart of FIG. 10. First, in step S101, the aggregation frame creating section 322 of the wireless base station 101 integrates a plurality of MAC frames and creates one aggregation frame. Then, in step S102, the transmission section 311 of the wireless base station 101 transmits the aggregation frame to the wireless terminal 102. After the transmission of the aggregation frame, the wireless base station 101 stands by for transmission for a response-waiting time (Rsp_Time) measured by the watchdog timer 326 in step S103. However, the wireless carrier sensing section 313 of the wireless base station 101 performs carrier sensing during this Rsp_Time period.

As a result of the carrier sensing, when the wireless carrier sensing section 313 detects no radio signal in the wireless channel within the Rsp_Time period (this is called an idle state) in step S104, i.e., when a wireless signal of, for example, a power level greater than or equal to a predetermined threshold (for example, −62 dBm) is not detected, the transmission section 311 of the wireless base station 101 performs retransmission processing of the aggregation frame. In this case, prior to the retransmission of the aggregation frame, the transmission frame selection section 324 determines in step S105 whether or not the retransmission limited number of times N (N is an integer equal to or greater than 0, for example, 4 to 7) is greater than 0.

When the retransmission limited number of times N is greater than 0, the transmission section 311 of the wireless base station 101 retransmits the same aggregation frame under the instruction from the transmission frame selection section 324 in step S106. Further, the transmission frame selection section 324 decreases the number N by one in step S107, and stands by for transmission for a response-waiting time in step S103.

Accordingly, when the wireless channel is in the idle state during the response-waiting time, the wireless base station 101 repeats the processing of steps S103 to S107 until the retransmission limited number of times N becomes 0. When the retransmission limited number of times N becomes 0, the transmission of the aggregation frame is stopped.

When a result of the determination in step S104 is No, i.e., after the transmission section 311 of the wireless base station 101 transmits the aggregation frame to the wireless terminal 102 under the instruction from the transmission frame selection section 324, when the wireless carrier sensing section 313 detects a radio signal in the wireless channel (this is called a busy state) as a result of performing carrier sensing in the Rsp_Time period, for example, when the wireless carrier sensing section 313 detects a wireless signal of, for example, a power level greater than or equal to a predetermined threshold (for example, −62 dBm), the wireless carrier sensing section 313 determines in step S108 whether or not the radio signal is a delivery acknowledgment response frame.

When the reception frame analyzing section 325 determined in step S108 that a delivery acknowledgment response frame has not been normally received, the transmission section 311 of the wireless base station 101 transmits a delivery acknowledgment request frame under the instruction from the transmission frame selection section 324. Incidentally, in the above description, the expression “when a radio signal is detected in the wireless channel, but a delivery acknowledgment response frame is not normally received” implies “when an error is detected as a result of a check on the FCS added to the MAC frame”, “when an error is not detected as a result of an FCS check, but the MAC frame is a MAC frame other than a delivery acknowledgment response frame”, or “when a radio signal is detected, but it is not recognized as a physical frame provided in the IEEE 802.11 standard”. In this case, prior to the transmission of a delivery acknowledgment request frame, the transmission frame selection section 324 of the wireless base station 101 determines in step S109 whether or not the retransmission limited number of times M (M is an integer greater than or equal to 0, for example, 4 to 7) is greater than 0.

When the retransmission limited number of times M is greater than 0, the transmission section 311 of the wireless base station 101 transmits a delivery acknowledgment request frame under the instruction from the transmission frame selection section 324 in step S110. Further, the transmission frame selection section 324 subtracts 1 from M, and stands by for transmission for a Rsp_Time period in step S112.

Accordingly, after transmission of the delivery acknowledgment request frame, when a delivery acknowledgment response frame cannot be received, the wireless base station 101 repeats the processing of steps S108 to S112 until the retransmission limited number of times M becomes 0. When the retransmission limited number of times M becomes 0, the transmission of the delivery acknowledgment request frame is stopped.

Incidentally, when a delivery acknowledgment response frame is correctly received in step S108, the reception frame analyzing section 325 of the wireless base station 101 confirms the MAC header, starting point sequence number, bitmap field, and the like, and confirms, in step S113, whether or not the MAC frames have successfully been transmitted. When all the MAC frames have successively been transmitted, the transmission processing is terminated. When any MAC frame that has been unsuccessfully transmitted is confirmed, the transmission frame selection section 324 of the wireless base station 101 performs retransmission processing of the unsuccessfully transmitted MAC frame in step S114.

In the sequence shown in FIG. 8, the transmission processing of steps S101 to S107 in the flowchart of FIG. 10 is executed. In this sequence, it is considered that the wireless terminal 102 has not been able to receive an aggregation frame in the least judging from the fact that the wireless channel has been in the idle state after the aggregation frame has been transmitted from the wireless base station 101. In such a case, the efficiency is made better by retransmitting the same aggregation frame, and transmitting the MAC frame to the wireless terminal 102 and requesting the wireless terminal 102 to transmit a delivery acknowledgment response frame, than by transmitting, from the wireless base station 101, a delivery acknowledgment request frame for only requesting a delivery acknowledgment response frame.

Further, in the sequence shown in FIG. 9, the transmission processing of steps S101 to S104, and the transmission processing of steps S108 to S112 in the flowchart of FIG. 10 are executed. In this sequence, it is considered that the wireless terminal 102 has been able to receive the aggregation frame, and has transmitted a delivery acknowledgment response frame, but the wireless base station 101 has not been able to correctly recognize the delivery acknowledgment response frame because of the adverse state of the wireless environment judging from the fact that the wireless channel has been in the busy state after the aggregation frame has been transmitted from the wireless base station 101. In such a case, the wireless terminal 102 has already been able to receive the aggregation frame, and hence, if the same aggregation frame is retransmitted, the transmission time is superfluously wasted. Accordingly, the wireless base station 101 transmits a delivery acknowledgment request frame requesting a delivery acknowledgment response frame, confirms the bitmap field of the delivery acknowledgment response frame, and thereafter retransmits a MAC frame that needs to be retransmitted, whereby superfluous transmission time can be cut.

According to the first embodiment, after an aggregation frame is transmitted, when a delivery acknowledgment response frame is not received within the response-waiting time, by selecting one of retransmission of the same aggregation frame and transmission of a delivery acknowledgment request frame in accordance with the information on the result of performing carrier sensing of the wireless channel in the response-waiting time, it is possible to realize an improvement in the throughput performance, and prevent the efficiency of the overall wireless communication system from being lowered by an occurrence of a superfluous frame exchange.

A second embodiment is based on the first embodiment, and a difference between these embodiments will be mainly described below.

The second embodiment differs from the first embodiment in the point that after the wireless base station 101 in FIG. 1 transmits an aggregation frame, when the wireless channel is in the idle state during the response-waiting time, control is performed in such a manner that the aggregation frame is retransmitted N times, and thereafter a delivery acknowledgment request frame is transmitted M times. Incidentally, the configuration of the wireless communication apparatus is the same as that shown in FIG. 3.

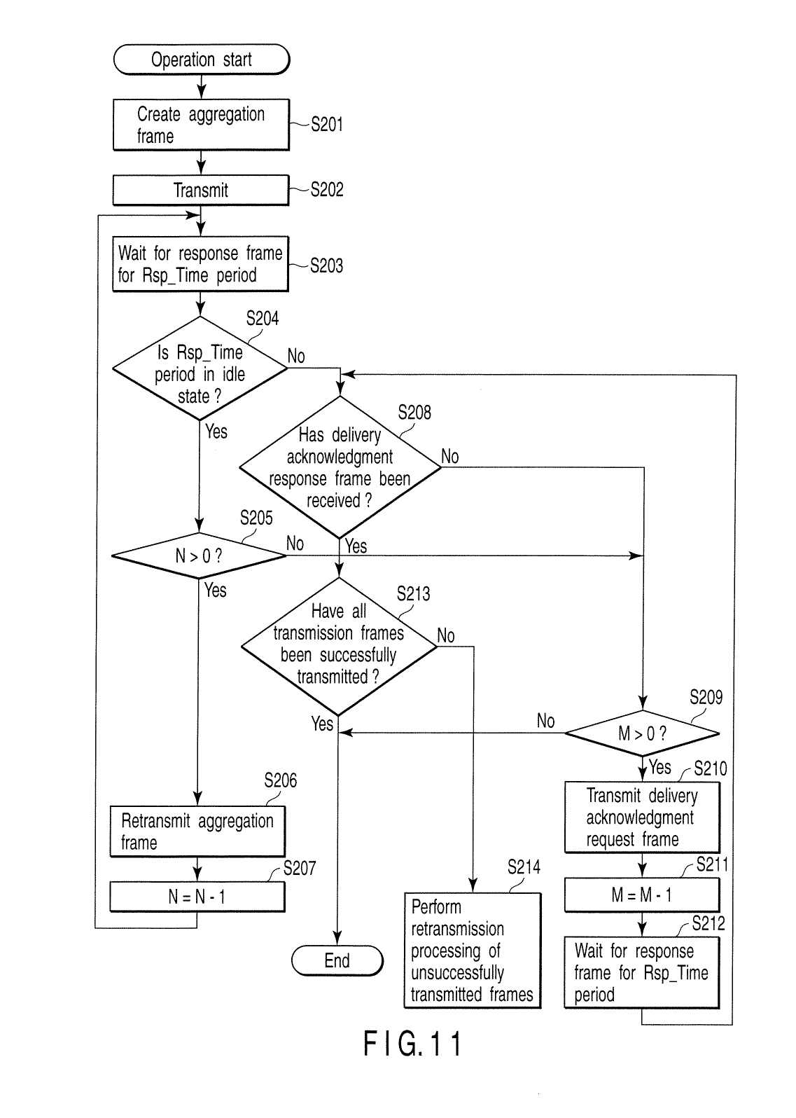

The transmission control in the second embodiment is shown in the flowchart of FIG. 11.

In the first embodiment, when the number of times of retransmitting an aggregation frame by the wireless base station 101 reaches a limited number of times, the control is performed so as to stop the retransmission of the aggregation frame. However, if the destination wireless terminal disappears from the BSS, superfluous frame transmission is continued. Therefore, the above control is not desirable in such a case.

Thus, in the second embodiment, after retransmitting the aggregation frame N times, the transmission frame selection section 324 of the wireless base station 101 switches the transmission to transmission of a delivery acknowledgment request frame. Here, the delivery acknowledgment request frame is transmitted M times. Although the transmission time of the aggregation frame depends on the frame length thereof and the transmission rate, the transmission time of the aggregation frame is longer than the transmission time of the delivery acknowledgment request frame in many cases.

Accordingly, by switching the frame to be transmitted from the aggregation frame to the delivery acknowledgment request frame as described above, it becomes possible to cut the time for transmitting a superfluous frame when the destination wireless terminal is absent from the BSS.

Incidentally, in this case, although setting of the value of the transmission limited number of times of each frame depends on the management policy, assuming that the retransmission limited number of times of the aggregation frame in the first embodiment is N1, and the retransmission limited number of times of the aggregation frame, and the transmission limited number of times of the delivery acknowledgment request frame in the second embodiment are N2 and M2, the transmission limited numbers of times of the respective frames may be set to satisfy the following expression.

N1=N2+M2(N2<M2)

By setting the value of N2 to a small value in an appropriate range, the transmission time of the superfluous aggregation frame is reduced.

According to the second embodiment, after transmitting the aggregation frame, if a delivery acknowledgment response frame is not received within the response-waiting time, when the same aggregation frame is retransmitted, the retransmission number of times of the aggregation frame is made small, and the delivery acknowledgment request frame is transmitted instead. As a result of this, if the destination wireless terminal disappears from the BSS, it becomes possible to reduce the superfluous time caused by transmitting a useless aggregation frame, and prevent the efficiency of the overall wireless communication system from being lowered.

A third embodiment is based on the first embodiment, and a difference between the third embodiment and the first embodiment will be mainly described below.

The third embodiment differs from the first embodiment in the point that after the wireless base station 101 in FIG. 1 transmits an aggregation frame, when the wireless channel is in the busy state during the response-waiting time, an aggregation frame into which new (having the advanced sequence numbers) MAC frames are integrated is transmitted.

Incidentally, the configuration of the wireless communication apparatus is basically identical with that shown in FIG. 3. However, when a delivery acknowledgment response frame is received, the aggregation frame creating section 322 selects creating of an aggregation frame into which MAC frames to be retransmitted are integrated or creating of an aggregation frame into which new MAC frames are integrated in accordance with the bit string of the bitmap field extracted by the reception frame analyzing section 325.

In the first embodiment, control is performed in such a manner that after the wireless base station 101 transmits the aggregation frame to the wireless terminal 102, carrier sensing is performed during the Rsp_Time period, and when it is detected that the wireless channel is in the busy state, and a delivery acknowledgment response frame is not normally received as a result of performing the carrier sensing, a delivery acknowledgment request frame is transmitted. However, new MAC frames may be transmitted instead.

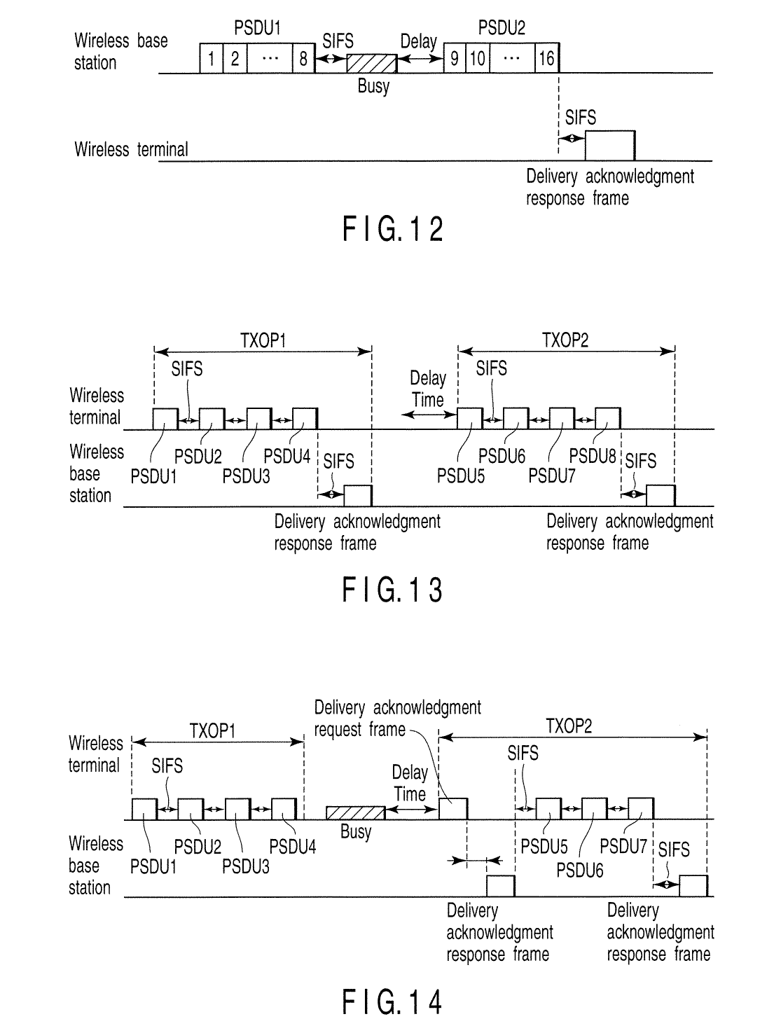

By performing control in this way, the wireless base station 101 can request the wireless terminal 102 to transmit a delivery acknowledgment response frame, and can transmit the latest MAC frames having the advanced sequence numbers. A frame sequence example realized by such control is shown in FIG. 12.

In this sequence, after the wireless base station 101 transmits an aggregation frame, the wireless channel is in the busy state, and hence the wireless terminal 102 can receive the first aggregation frame, and transmits a delivery acknowledgment response frame. However, it is conceivable that the wireless base station 101 cannot correctly recognize the delivery acknowledgment response frame because of the state of the wireless environment. In such a case, the wireless terminal 102 has already been able to receive the first aggregation frame, and hence the wireless base station 101 requests the delivery acknowledgment response frame, and transmits an aggregation frame having advanced sequence numbers, whereby the throughput can be improved.

After a new aggregation frame is transmitted, if a delivery acknowledgment response frame cannot be received again, a further advanced aggregation frame may be transmitted. In this case, a degree to which a sequence number included in the MAC frame to be transmitted is advanced may be determined according to an amount of the buffer for storing frames managed by the transmission side or may be determined according to an amount of the frame buffer managed by the reception side. Further, the above degree may be determined according to the length of the bitmap field that can be set in the delivery acknowledgment response frame. When the sequence number of the MAC frame cannot be further advanced because of the limiting value, control may be performed in such a manner that a delivery acknowledgment request frame is transmitted so as to request a delivery acknowledgment response frame.

According to the third embodiment, after transmitting the aggregation frame, when a delivery acknowledgment response frame is not received within the response-waiting time, if the wireless channel is busy as a result of performing carrier sensing with respect to the wireless channel, by transmitting an aggregation frame into which the latest MAC frames having advanced sequence numbers are integrated, an improvement in the throughput performance can be realized.

A fourth embodiment will be described below. According to the IEEE 802.11e standard in which the MAC layer is extended in order to improve the quality of service (QoS) in the IEEE 802.11 wireless LAN standard, as one of methods for improving the throughput, a transmission opportunity (TXOP) in which a plurality of frames can be continuously transmitted at minimum frame intervals is provided. However, in order to acquire a TXOP, it is necessary to perform a back off procedure provided by the IEEE 802.11 standard.

In the back off procedure, each wireless communication apparatus generates random number values uniformly distributed in a specified range, performs carrier sensing at predetermined intervals, when the wireless channel is in the idle state, the generated random number values are subjected to subtraction, and a wireless communication apparatus which first reaches 0 can transmit a frame. Thus, the probability of occurrence of a collision between frames is lowered. The back off procedure needs to be performed before obtaining the TXOP, and hence the same wireless communication apparatus cannot always acquire the TXOP continuously.

A sequence example in which a wireless terminal 102 acquires a TXOP, and transmits PSDUs at SIFS intervals is shown in FIG. 13. In the sequence example shown in FIG. 13, the wireless terminal 102 receives a delivery acknowledgment response frame at the end of the TXOP. In such a case, it is possible to confirm that a MAC frame having what sequence number can be received by the wireless base station 101 for each TXOP.

In the sequence example shown in FIG. 14, the case is shown where the wireless terminal 102 does not receive a delivery acknowledgment response frame in the TXOP1. At this time, there is the possibility of another wireless terminal transmitting a frame to the wireless base station 101 before the wireless terminal 102 acquires the TXOP2. In such a case, the wireless base station 101 may reset the sequence number of the frame received from the wireless terminal 102, and may possibly update the sequence number to a sequence number of the frame received from another wireless terminal.

When the wireless terminal 102 does not receive a delivery acknowledgment response frame in the TXOP1, if the wireless carrier sensing section 313 of the wireless terminal 102 determines that the wireless channel is in the busy state as a result of the carrier sensing performed after the termination of the TXOP1, another wireless terminal may have transmitted a frame as shown in FIG. 14. If the wireless base station 101 has rest a sequence number of the frame received from the wireless terminal 102, there is the possibility of the wireless terminal 102 being late in recognizing a MAC frame that needs to be retransmitted.

In order to avoid this, if the wireless carrier sensing section 313 detects that the wireless channel is in the busy state after the termination of the TXOP1, the wireless terminal 102 transmits a delivery acknowledgment request frame to the wireless base station 101 immediately after the acquisition of the TXOP2, and receives a delivery acknowledgment response frame.

By performing the above processing, it is possible for the wireless terminal 102 to make an inquiry at the wireless base station 101 to confirm whether or not reception records obtained so far are stored. As a result of the acknowledgment, when the wireless base station 101 has reset the frame reception records, the wireless terminal 102 can perform processing of retransmitting MAC frames for which delivery acknowledgment is not grasped. Conversely, when the wireless base station 101 has stored frame reception records, the wireless terminal 102 may advisably perform retransmission processing corresponding to the reception record or transmission processing of a new frame.

According to the fourth embodiment, when while the wireless terminal does not receive a delivery acknowledgment response frame in a certain TXOP, the TXOP is terminated, and as a result of carrier sensing performed after the termination of the TXOP, it is determined that the wireless channel is in the busy state, a delivery acknowledgment request frame is transmitted to the wireless base station at the beginning of a TXOP acquired next, and a delivery acknowledgment response frame is received.

As a result of this, the wireless terminal can confirm whether or not the wireless base station stores the reception records obtained so far in the early stage, and can take measures of retransmitting MAC frames for which delivery acknowledgment is not grasped, and hence it is possible to prevent retransmission of MAC frames which must be retransmitted from being delayed more than necessary.

As described above, according to this embodiment, in a wireless communication system using a frame aggregation function for integrating a plurality of MAC frames into one frame, a transmission source wireless apparatus transmits an aggregation frame into which a plurality of MAC frames are integrated to a destination wireless apparatus. Upon receipt of the aggregation frame, the destination wireless apparatus creates a delivery acknowledgment response frame, and transmits the created delivery acknowledgment response frame to the transmission source wireless apparatus. Information indicating whether or not the destination wireless apparatus has been able to receive each of the MAC frames in the aggregation frame is included in the delivery acknowledgment response frame.

In such a wireless communication system, when a delivery acknowledgment response frame is not received for a certain period of time, the transmission source wireless apparatus retransmits the same aggregation frame as that already transmitted or transmits a delivery acknowledgment request frame according to the wireless environment assumed from the reception status, whereby the transmission source wireless apparatus can request a delivery acknowledgment response frame.

It is not provided in the conventional technique which one of the two frames described above should be transmitted. However, in this embodiment, by selecting the appropriate frame on the basis of the wireless state after the transmission of the aggregation frame, and transmitting the appropriate frame, it is possible to realize an improvement in the throughput performance of the wireless communication system.

According to this embodiment, a wireless communication apparatus that improves the throughput of the wireless communication system can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless communication apparatus comprising:
an aggregation frame creating section which creates an aggregation frame into which a plurality of MAC frames are integrated;
a transmission section which transmits the aggregation frame created by the aggregation frame creating section to a destination apparatus;
a reception section which receives a delivery acknowledgment response frame including information indicating whether or not each of the MAC frames in the aggregation frame has safely been received from the destination apparatus;
a time measurement section which measures a time for which reception of the delivery acknowledgment response frame is waited; and
a selection section which selects retransmission of the aggregation frame to the destination apparatus or transmission of a delivery acknowledgment request frame requesting the delivery acknowledgment response frame when the reception section has not received the delivery acknowledgment response frame after the time measured by the time measurement section has reached a predetermined time.

2. The wireless communication apparatus according to claim 1, further comprising a wireless carrier sensing section which performs wireless carrier sensing during a standby time for which reception of the delivery acknowledgment response frame is waited, wherein
the selection section selects transmission of the aggregation frame or transmission of the delivery acknowledgment request frame according to a sensing result of the wireless carrier sensing section, and instructs the transmission section to transmit the selected frame to the destination apparatus.

3. The wireless communication apparatus according to claim 2, wherein
the sensing result of the wireless carrier sensing section is a sensing result of a wireless signal having a power level greater than or equal to a predetermined threshold.

4. The wireless communication apparatus according to claim 2, wherein
when a carrier sense signal is not sensed by the wireless carrier sensing section, the selection section selects the aggregation frame which has been transmitted most recently, and instructs the transmission section to retransmit the aggregation frame, and when a carrier sense signal is sensed by the wireless carrier sensing section, the selection section selects the delivery acknowledgment request frame, and instructs the transmission section to transmit the delivery acknowledgment request frame.

5. The wireless communication apparatus according to claim 4, wherein
the selection section instructs the transmission section to retransmit the aggregation frame a predetermined number of times.

6. The wireless communication apparatus according to claim 4, wherein
the selection section instructs the transmission section to retransmit the delivery acknowledgment request frame a predetermined number of times.

7. The wireless communication apparatus according to claim 1, further comprising an analyzing section which analyzes the delivery acknowledgment response frame received by the reception section, wherein
the analyzing section analyzes whether or not the MAC frame is successfully received on the basis of the delivery acknowledgment response frame.

8. The wireless communication apparatus according to claim 7, wherein
when the analyzing section confirms that the MAC frame is unsuccessfully transmitted, the selection section performs retransmission processing of the MAC frame.

9. The wireless communication apparatus according to claim 1, wherein
when the reception section has not received the delivery acknowledgment response frame, the selection section instructs the transmission section to retransmit the aggregation frame to the destination apparatus a first predetermined number of times, and thereafter transmit the delivery acknowledgment request frame a second predetermined number of times.

10. The wireless communication apparatus according to claim 9, wherein
the first predetermined number of times is less than the second predetermined number of times.

11. The wireless communication apparatus according to claim 2, wherein
when a carrier sense signal is sensed by the wireless carrier sensing section, the selection section selects an advanced aggregation frame, and instructs the transmission section to transmit the advanced aggregation frame.

12. The wireless communication apparatus according to claim 11, wherein
after the advanced aggregation frame is transmitted, when the reception section does not receive the delivery acknowledgment response frame, the selection section selects a further advanced aggregation frame and instructs the transmission section to transmit the further advanced aggregation frame.

13. The wireless communication apparatus according to claim 1, further comprising an analyzing section which analyzes the delivery acknowledgment response frame received by the reception section, wherein
the aggregation frame creating section selects creating of an aggregation frame into which MAC frames to be retransmitted are integrated or creating of an aggregation frame into which advanced MAC frames are integrated in accordance with a bit string of a bitmap field extracted by the analyzing section.

14. The wireless communication apparatus according to claim 1, further comprising a wireless carrier sensing section which performing wireless carrier sensing after a termination of a first transmission opportunity when the reception section has not received the delivery acknowledgment response frame, wherein
when a carrier sense signal is sensed by the wireless carrier sensing section, the selection section instructs the transmission section to transmit the delivery acknowledgment response frame immediately after acquisition of a second transmission opportunity.
